(19) United States
(12) Patent Application Publication
(10) Pub. No.: US 2006/0100855 A1
(43) Pub. Date: May 11, 2006

(54) Disambiguation method for complex sentences

(76) Inventor: Suan Dara Rozen, Sudbury, MA (US)

Correspondence Address: Susan D. Rozen, P.O. Box 237, Wayland, MA, 01778, US

(21) Appl. No.: 11/260,417

(22) Filed: Oct. 27, 2005

Related U.S. Application Data
(60) Provisional application No. 60/622,449, filed on Oct. 27, 2004.

(51) Int. Cl. G06F 17/27

(52) U.S. Cl. 704/9

(57) ABSTRACT

A method allows the better disambiguation and understanding of complex sentences by the mapping of syntactic elements to their thematic roles. The words and phrases form canonical sound patterns for comprehension which improves on basic reading strategies which rely on simple heuristics and pattern matches. The method can be taught by a live person or computer, self-taught via passive or active courseware in written or multimedia form, in an active or passive fashion, or via the Internet with real-time or non-real-time interactions, for training humans or computers.

### CROSS-REFERENCE TO RELATED APPLICATIONS

This application incorporates by reference in its entirety, and claims priority to and benefit of, U.S. Provisional Patent Application No. 60/622,449, filed on 27 Oct. 2004.

### DEFINITIONS

The following definitions are intended to elucidate the concepts herein.

Blockage occurs when the structure or conceptual load of the text is so complex that comprehension becomes impeded, interfering with the automaticity of the reading process. Sentence blockage failure occurs at the point of the least complex sentence where the reader cannot understand the meaning of that sentence.

Bottom-up strategies are used by readers to analyze the text from the word, clause and sentence level, to the higher conceptual levels. Bottom-up strategies include such strategies such as word focus, intrasentential analysis, re-reading and a lexico-grammatical focus.

Canonical Forms are phrasal and sentence types in which the thematic roles of who does what to whom (and then sometimes, when, where, why and how) are be ordered in a way that maps to the syntactic objects such as nouns and verbs which can be presented in a typical syntactic sequence such as noun-verb, or noun-verb-noun (e.g.: NV, NVN, also NNV and NVNN, etc.). The canonical sound patterns of a sentence consists of sounding it out in sequences of who does what to whom.

Chunking is a technique to group words together into meaning-making units, such as phrases and clauses which help to modify or clarify the main thematic or syntactic elements of the sentence.

Cognitive strategies such as bottom-up and top down strategies, are those which can be taught and are described as “learning strategies”.

Direct, explicit comprehension instruction usually means instruction in one or more of: comprehension strategies such as summarizing, identifying text structure and visual clues, calling on prior knowledge, using graphic organizers, questioning, clarifying, predicting, and summarizing as part of reciprocal teaching; comprehension monitoring and metacognition instruction; teacher modeling; scaffolded instruction, and apprenticeship models. These have not involved instruction in, or understanding of, the nature of the sound structure of the complex sentence, or of its importance in simplification and ultimate comprehension. Also, the primacy of the sentence as a critical unit of reading comprehension is usually not an inherent part of the instruction.

Disambiguation is the process of re-ordering or grouping words in a sentence so that they comprise meaning units or “chunks” for comprehension and determining the best meaning of a word, phrase or sentence.

Listening Comprehension is the process of simultaneously extracting and constructing meaning through the interaction and involvement with spoken language.

Parsing is chunking sentences into words and phrases and identifying their syntactic categories (verbs, nouns, etc.) for analysis in comprehension. The parser assigns syntactic structures to sentences. Verbs and nouns also include, for the purpose of this method, their direct modifiers when present for the purposes of chunking them into phrasal units.

Reading Comprehension is the process of simultaneously extracting and constructing meaning through the interaction and involvement with written language.

Schematic processes are those processes that use experience to bring prior knowledge to bear in sentence comprehension. They are related to the processes associated with pragmatics, which apply practical knowledge and good sense to the comprehension task.

Sentence is a sequence that native speakers of a language intuitively believe to covey a complete proposition in a linguistically acceptable form. The natural unit of linguistic knowledge is the intuition that a sequence of word sounds is a sentence.

Sentence complexity is the measurement in quantitative and qualitative terms of the difficulty the reader has in understanding a particular sentence. Within a particular context, it may be a function of the length, lexical choice, and syntactic structure used by the author of the sentence.

Surface code is the wording and syntax of a sentence.

Syntax is that part of grammar which deals with the way that words are put together, or ordered, to form constituents such as phrases and clauses. It is the way in which the intended relations among words are specified.

Syntactic awareness is the insight that sentences have structure, and that structure can be used to understand the meaning of the sentence.

Syntactic awareness as a reading strategy is the use of syntactic awareness to simplify complex sentences by converting them to canonical forms, more fully described below.

Syntactic comprehension skills build on the ability of readers to explicitly identify, reflect on, and manipulate the main syntactic components in a sentence that lead to understanding of the thematic roles that they play. The syntactic components of a sentence are principally the nouns, verbs, clauses and phrases.

Thematic roles are semantic constituents of sentences such as the actor or agent that help the reader identify who does what to whom in many sentence types. The secondary roles often include information on what, when, where and how the actor or agent is operational.

Top-down strategies are used to analyze text from the larger semantic concepts such as theme, genre, and context to determine meaning. Examples of top-down strategies are pre-reading, schema, prediction, getting the gist of a text, and skimming.

### BACKGROUND

The present invention relates to syntactic awareness as a reading strategy for sentence comprehension. Many people, when confronted with non-simple materials, frequently cannot derive meaning from the text. As they read, they may fluently decode and understand the words, but become confused because they do not understand the text. Many either stop reading or simply skip over sentences they do not understand, and even good readers reach a point of impairment at which they do not understand the text. This blockage is seen in people worldwide at all ability levels, and while the above average reader may exhibit the problem less frequently when confronted with one or two difficult sentences, the poor and average reader may block on an entire passage. This blockage is particularly noticeable when they are confronted with challenging materials that are found in narrative works by such authors as Hawthorne, Shelley, and Dickens, in expository work such as in the Federalist Papers, as well as a multitude of other present day, historical, and foreign language materials.

Some basic word readers, i.e. those that understand individual words, do not understand that the sentence is a basic unit of comprehension, and when they read text that is difficult, they complain that they can read it, but they do not understand it. They are accustomed to reading simple sentences from which it is easy to derive meaning, but it is likely that they use simple heuristics or simple pattern matching to allow them to identify the meaning-making words, i.e. the thematic roles that are already placed in their canonical sound sequence. However, when the sentences are longer and/or more complex, i.e. the thematic roles are not in their canonical sequence, or there are multiple sequences, they may be fluently reading the words, but they do not map them to the proper thematic roles to create comprehension.

Struggling readers with long and/or complex texts may begin to understand the context of the text by rereading sentences they can disambiguate and then compare them to prior sentences. When the find a sentence that they cannot understand, they can then rely on the invention herein. With practice, only occasionally will readers have to stop for complex sentences, this should make reading easier because they will have developed more sophisticated reading heuristics, and become more fluent comprehenders.

Despite the importance of higher-level literacy skills, reading levels in the United States are unimpressive. One measure comes from the scores of the Reading Report Card of the National Assessment of Educational Progress (NAEP) which regularly finds that approximately two thirds of twelfth graders are below a proficient level in reading achievement and thus do not demonstrate competency over challenging subject matter. In 1997 the United States Congress empowered a national panel (the “National Reading Panel”, or “NRP”) to assess the status of research-based knowledge, including the effectiveness of various approaches to teaching people to read better. The NRP found results that indicated the effectiveness of some of the reading comprehension strategies in the early grades. However, the results of the NAEP's national report card for reading show no statistical change in reading scores over the last three decades for seventeen year-olds and twelfth graders despite a doubling of per pupil expenditures on a constant dollar basis. As the NRP noted, strategy use should lead to skill improvement in reading, although it frequently does not.

It would be desirable, therefore, to provide a method whereby instruction can be given in how to read at a proficient and advanced level and be able to access more of the world's great literature and contemporary commentary, for example. Much of what is important is not written in simple sentences, but contains sentences which are complex and hard to read. Sentences can be hard to read for a variety of factors, including complex or unusual syntax, length, unknown words, difficult logic, or references to things that are not in the reader's experience base. It is purpose of this method to allow the instructional means (by computer, by instructional texts, by audio texts, etc.) to be better able to disambiguate complex sentences and therefore understand more of the text.

Those knowledgeable in the art recognize that the techniques that are available to help disambiguate complex sentences consist of using the context of the surrounding words, pictures, or sounds to help guess at the meaning of the text. Direct, explicit comprehension instruction at the complex sentence level does not directly address the core skills of being able to identify the subject of the sentence, the ability to relate the main subject to the main verb, or the importance of the canonical sound structure of complex sentences. Without this skill in complex sentences, it is difficult to impossible to map these to their meaning-making roles in the sentence, i.e., the thematic roles of who does what to whom. After decades of research, it has been discovered that it important to be able to sound out words and thus phonics and phonemic awareness have become important teaching tools at early reading levels. However, the leap to make a sound-to-meaning analogy with complex sentences has not yet been made. Yet this is a key tool in overcoming the barrier to complex sentence understanding and getting our nation's students beyond the few (only about one third) who are proficient readers.

Because comprehension failure of readers typically occurs at the sentence level and reading comprehension failure results in part from a mismatch between the syntactic complexity of sentences and the degree of sophistication of the strategies that people bring to bear which are necessary for their disambiguation, then by engaging more of the underlying resources that are used in the process of disambiguation, and by providing awareness of the important syntactic constituents from which meaning is derived, the scope of tools that all people everywhere, including less proficient readers, bring to bear on the reading process, can be enlarged.

A great deal of research has justifiably focused on the beginning stages of reading and on the alphanumeric identification, phonemic, and orthographic processes necessary to decode words, with the emergence of significant insights, for example, the importance of phonemic awareness. There is also a great deal of research on the higher level processes that can be used in a top-down fashion to help identify the meaning of sentences by using the context of the passage. There are, however, no useful, easily taught and understood methods that address the role of syntactic processes as a point of leverage in increasing reading ability with syntactically complex sentences, nor are there any useful, easily taught and understood methods that deals with improving syntactic processes to help with these harder materials.

With this method the human language parser can, with proper training, be modified to increase the depth and breadth of its capabilities in disambiguating complex sentences and that with experience, this capability can become a fluent skill. This modification occurs through the direct explicit instruction and/or interaction with the main syntactic components of complex sentences and in the experience of mapping these components successfully to the meaning components of the sentence.

Almost all people around the world are able to speak from youth with great ease, but many struggle with reading, especially at the higher levels of text complexity. Although the reasons for this are not well understood, it is well known that the ear (and its attendant machinery which make listening possible) is better attuned to speech signals in which the sequence of words form syntactically correct sentences, and is able to detect the sentence signal from noise better than words which do not form such sequences. It may also be the case that the ear is better attuned (via nature or nurture) to words which are sequenced in a canonical form, which is a common mode of verbal communications, at least among languages of Indo-European origin. It may also be the case that no sentence can be understood unless it is re-stated explicitly or internally, in who—does what—to whom semantic sequences.

The method described herein to improve the reading process for complex, non-canonical sentences, is one in which the sequence of words is reformulated into simple canonical formats and sequences that the ear is attuned to. In providing a matched and properly formatted input to the listening system, this method may be taking advantage of the inherently powerful mechanisms which match the speech signal to words and the meanings of those words.

### SUMMARY OF THE INVENTION

A method allows a person to be better able to read complex sentences. The method comprises the steps of identifying the main verb and/or verbs in the sentence (which is relatively easy to do even in complex sentences) which then allows the reader to readily find the subject and/or subjects of the verb. By then mapping to the canonical sequence of thematic roles of who does what to whom (and sometimes when, where and how), the reader is then able to assign (or chunk together) the other words of the sentence into meaningful groups. The function of words or groups of words that refer to antecedent words or groups of words may also be demonstrated to further help in the separation and chunking of the thematic roles.

### BRIEF DESCRIPTION OF THE DRAWING

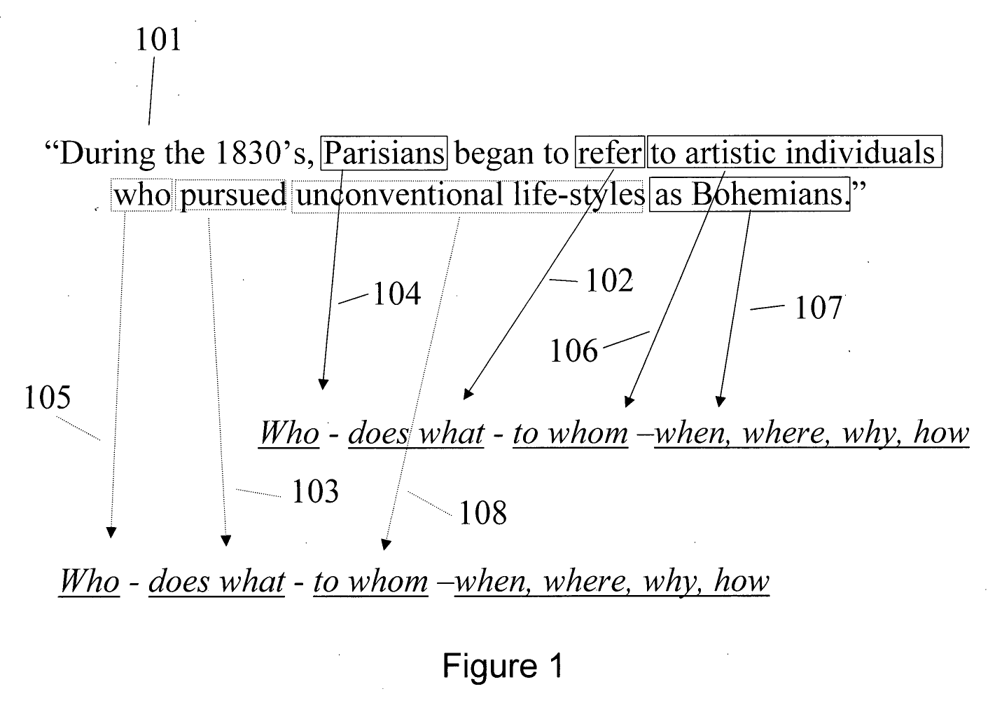

The following FIGURE 1 illustrates certain mappings of verbs and associated subjects of a complex sentence into its canonical sequences. This depicted embodiment is to be understood as illustrative of the invention and not as limiting in any way.

### DETAILED DESCRIPTION OF THE ILLUSTRATED EMBODIMENT

To provide an overall understanding of the invention, certain illustrative practices and embodiments will now be described. The systems and methods described herein can be adapted, modified, and applied to other contexts; such other additions, modifications, and uses will not depart from the scope hereof. Although the descriptions are focused on interacting with a human, the participants, including the teacher and the student in the invention, may be a combination of synthetically-generated participants including without limitation, robots, websites, cell phones, personal digital assistants, voice synthesis or voice response systems, computer-generated participants which may be programmed with knowledge, or which may be configured to learn from present and/or past data and which may be used to teach other participants, human, computer, or otherwise:

In one aspect, an embodiment that could be taught by a computer-aided-instructional modality, or a person following the invention's methodology from a textbook, to a person or group of persons, is as shown in FIGURE 1. The methodology begins with a sample sentence 101, for example: “During the 1830's, Parisians began to refer to artistic individuals who pursued unconventional life-styles as Bohemians.” First identify highlight the verb or action words “began” and “pursued” and map them as in 102 and 103 to their does what thematic roles. Then identify the subjects which correspond to the verbs and map these to the who role as in 104 and 105. Then map the words which correspond to their subject and verb to the to whom part of the canonical sound sequence as in 106, and 108. Optionally, map the words corresponding to the when, where why how role as in 107. Sound out the canonical sequences and re-read the sentence with comprehension.

1. A method for teaching a student how to disambiguate a complex sentence comprising the steps of:
a. teaching the student to identify the main verb of the complex sentence and to map it to the who thematic role;
b. teaching the student to identify the subject of the main verb of the complex sentence and to map it to the does what thematic role; and,
c. teaching the student to sound out in order the words corresponding to the who, and the does what, thematic roles.

2. A method for teaching a student how to disambiguate a complex sentence comprising the steps of:
a. teaching the student to identify the main verb of the complex sentence and to map it to the who thematic role;
b. teaching the student to identify the subject of the main verb of the complex sentence and to map it to the does what thematic role;
c. teaching the student to map the to whom words which correspond to the main verb of the complex sentence and to the subject of the main verb of the complex sentence to the to whom thematic role; and,
d. teaching the student to sound out in order the words corresponding to the who, the does what, and the to whom, thematic roles.

3. A method for teaching a student how to disambiguate a complex sentence comprising the steps of:
a. teaching the student to identify the main verb of the complex sentence and to map it to the who thematic role;
b. teaching the student to identify the subject of the main verb of the complex sentence and to map it to the does what thematic role;
c. teaching the student to map the to whom words which correspond to the main verb of the complex sentence and to the subject of the main verb of the complex sentence to the to whom thematic role;
d. teaching the student to map the when, the where, the why, and the how words which correspond to the main verb of the complex sentence and to the subject of the main verb of the complex sentence to the when, the where, the why, and the how, thematic roles; and
e. teaching the student to sound out in order the words corresponding to the who, the does what, the to whom, the when, the where, the why, and the how, thematic roles.

4. The method according to claim 1, wherein additionally a final step of teaching the student to re-read the complex sentence is performed.

5. The method according to claim 2, wherein additionally a final step of teaching the student to re-read the complex sentence is performed.

6. The method according to claim 3, wherein additionally a final step of teaching the student to re-read the complex sentence is performed.

7. The method according to claim 1 wherein the synthetically-generated participant is selected from the group consisting of teacher and student.

8. The method according to claim 2 wherein the synthetically-generated participant is selected from the group consisting of teacher and student.

9. The method according to claim 3 wherein the synthetically-generated participant is selected from the group consisting of teacher and student.

10. The method according to claim 4 wherein the synthetically-generated participant is selected from the group consisting of teacher and student.

11. The method according to claim 5 wherein the synthetically-generated participant is selected from the group consisting of teacher and student.

12. The method according to claim 6 wherein the synthetically-generated participant is selected from the group consisting of teacher and student.

13 The method according to claim 1 wherein the function of words or groups of words that refer to antecedent words or groups of words is demonstrated.

14 The method according to claim 2 wherein the function of words or groups of words that refer to antecedent words or groups of words is demonstrated.

15 The method according to claim 3 wherein the function of words or groups of words that refer to antecedent words or groups of words is demonstrated.

16 The method according to claim 4 wherein the function of words or groups of words that refer to antecedent words or groups of words is demonstrated.

17 The method according to claim 5 wherein the function of words or groups of words that refer to antecedent words or groups of words is demonstrated.

18 The method according to claim 6 wherein the function of words or groups of words that refer to antecedent words or groups of words is demonstrated.

19 The method according to claim 1, wherein the complex sentence language is Indo-European.

20 The method according to claim 2, wherein the complex sentence is Indo-European.

21 The method according to claim 3, wherein the complex sentence is Indo-European.

22. The method according to claim 1 wherein the teaching is accomplished by the use of teaching materials comprising at least one of a broadcast television system, a cable television system, a closed-circuit television system, the Internet, and an intranet.

23. The method according to claim 2 wherein the teaching is accomplished by the use of teaching materials comprising at least one of a broadcast television system, a cable television system, a closed-circuit television system, the Internet, and an intranet.

24. The method according to claim 3 wherein the teaching is accomplished by the use of teaching materials comprising at least one of a broadcast television system, a cable television system, a closed-circuit television system, the Internet, and an intranet.
